(19) United States
(12) Patent Application Publication
(10) Pub. No.: US 2023/0274249 A1
(43) Pub. Date: Aug. 31, 2023

(54) Barcode Reader with Platter Destabilizing Mechanism

(71) Applicant: ZEBRA TECHNOLOGIES CORPORATION, Lincolnshire, IL (US)

(72) Inventors: Yuri Astvatsaturov, Lake Forest, IL (US); Darran Michael Handshaw, Sound Beach, NY (US)

(21) Appl. No.: 17/683,081

(22) Filed: Feb. 28, 2022

(51) Int. Cl. G06Q 20/20; G06K 7/14

(52) U.S. Cl. CPC G06Q 20/208; G06K 7/1413

(57) ABSTRACT

Item weighing apparatuses, such as barcode readers with platters, having platter destabilizing mechanisms are disclosed herein. An example barcode reader includes a housing, a weigh platter assembly, an off-platter detection system, a platter destabilizing mechanism, and a controller. The weigh platter assembly includes a weigh platter having a first lateral edge and a second lateral edge and is configured to measure a weight of an object positioned on the weigh platter. The off-platter detection system is configured to detect an off-platter condition. The platter destabilizing mechanism is configured to destabilize the weigh platter in response to the off-platter detection system detecting the off-platter condition. The controller is in communication with the weigh platter assembly, the off-platter detection system, and the platter destabilizing mechanism and is configured to activate the platter destabilizing mechanism when the off-platter detection system detects the off-platter condition.

### BACKGROUND

In retail environments where weighted items are sold, obtaining accurate weight of these items is essential. To address this issue, various off-platter detection systems, such as those used for bioptic barcode readers with a weigh platter, have been developed. However, while the ability of these systems to effectively detect an off-platter event has been implemented with some success, there is still a further need for identifying means for communicating such events from the weighing apparatus to a point-of-sale (POS) system.

### SUMMARY

In an embodiment, the present invention is a barcode reader configured to be supported by a workstation. The barcode reader comprises a housing, a weigh platter assembly, an off-platter detection system, a platter destabilizing mechanism, and a controller. The housing has a lower housing portion and an upper housing portion extending above the lower housing portion. The weigh platter assembly includes a weigh platter having a proximal edge adjacent the upper housing portion, a first lateral edge extending non-parallel to the proximal edge, and a second lateral edge, opposite the first lateral edge, extending non-parallel to the proximal edge, and is configured to measure a weight of an object positioned on the weigh platter. The off-platter detection system is configured to detect an off-platter condition. The platter destabilizing mechanism is configured to destabilize the weigh platter in response to the off-platter detection system detecting the off-platter condition. The controller is in communication with the weigh platter assembly, the off-platter detection system, and the platter destabilizing mechanism and is configured to activate the platter destabilizing mechanism when the off-platter detection system detects the off-platter condition.

In another embodiment, the present invention is a barcode reader configured to be supported by a workstation. The barcode reader comprises a housing, a weigh platter assembly, an off-platter detection system, and a controller. The housing has a lower housing portion and an upper housing portion extending above the lower housing portion. The weigh platter assembly includes: a weigh platter having a proximal edge adjacent the upper housing portion, a first lateral edge extending non-parallel to the proximal edge, and a second lateral edge, opposite the first lateral edge, extending non-parallel to the proximal edge; a strain gauge, and a printed circuit board in analog communication with the strain gauge. The weigh platter assembly is configured to measure a weight of an object positioned on the weigh platter. The off-platter detection system is configured to detect an off-platter condition. The controller is configured to introduce cross-talk into the analog communication between the strain gauge and the printed circuit board when the off-platter detection system detects the off-platter condition.

In another embodiment, the present invention is a method for weighing an object positioned on a weigh platter assembly of a barcode reader, comprising the steps of: determining, using an off-platter detection system, if an off-platter condition is detected; and destabilizing the weigh platter, using a platter destabilizing mechanism, in response to the off-platter detection system detecting the off-platter condition.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a front perspective view of an example barcode reader;

FIG. 2 illustrates a side view of the barcode reader of FIG. 1 with a first example platter destabilizing mechanism;

FIG. 3 illustrates a side view of the barcode reader of FIG. 1 with a second example platter destabilizing mechanism;

FIG. 4 illustrates a side view of the barcode reader of FIG. 1 with a third example platter destabilizing mechanism;

FIG. 5 illustrates a side view of the barcode reader of FIG. 1 with a fourth example platter destabilizing mechanism; and

FIG. 6 illustrates a side view of the barcode reader of FIG. 1 with a fifth example platter destabilizing mechanism.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As used herein, references to barcode reader are understood to refer to barcode readers with a weigh platter, like bioptic barcode readers used in a retail (and typically grocery) environment. However, other barcode reader configurations with weighing means are to be considered to fall within the scope of the invention(s) disclosed herein. Moreover, methodologies and inventive concepts described herein can also be applied to non-barcode reader systems that have weighing and off-platter detection means.

Typical barcode readers and point-of-sale (POS) systems are configured where a transaction will not be allowed to proceed until a stable weight signal is received from a weigh platter assembly. The example barcode readers disclosed herein have platter destabilizing mechanisms that destabilize the weigh platter of the weigh platter assembly or introduce cross-talk into the communications within the weigh platter assembly when an off-platter detection systems determines that there is an off-platter condition so that the transaction will not proceed until the off-platter condition has been corrected and the destabilizing action ceases.

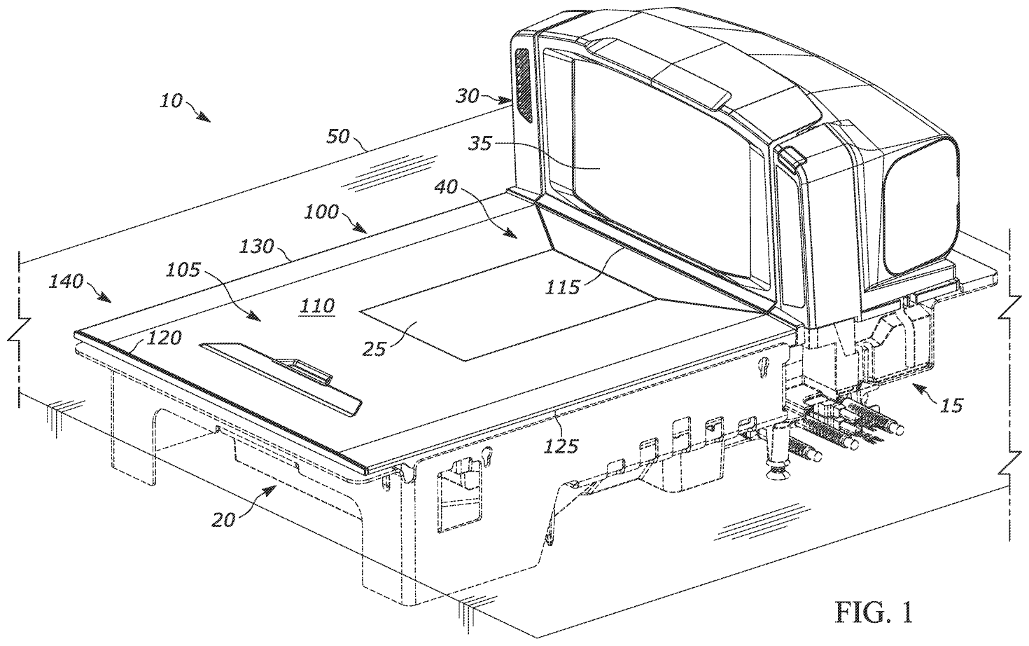

Referring to FIG. 1, an example barcode reader 10, such as the Zebra® MP7000 bioptic barcode reader, is shown and can be configured to be supported by a workstation 50, such as a checkout counter at a POS of a retail store. Barcode reader 10 has a housing 15 that houses a weigh platter assembly 100 and includes a lower housing portion 20 and an upper housing portion 30 that extends above lower housing portion 20. Upper housing portion 30 includes a generally vertical window 35 to allow a first set of optical components positioned within housing 15 to direct a first field-of-view through vertical window 35. In addition, if barcode reader 10 is a bioptic barcode reader, barcode reader 10 will include a generally horizontal window 25, which in the example shown is positioned in a weigh platter 105 of weigh platter assembly 100 to allow a second set of optical components positioned within housing 15 to direct a second field of view through horizontal window 25. The first and second fields of view intersect to define a product scanning region 40 of barcode reader 10 where a product can be scanned for sale at the POS.

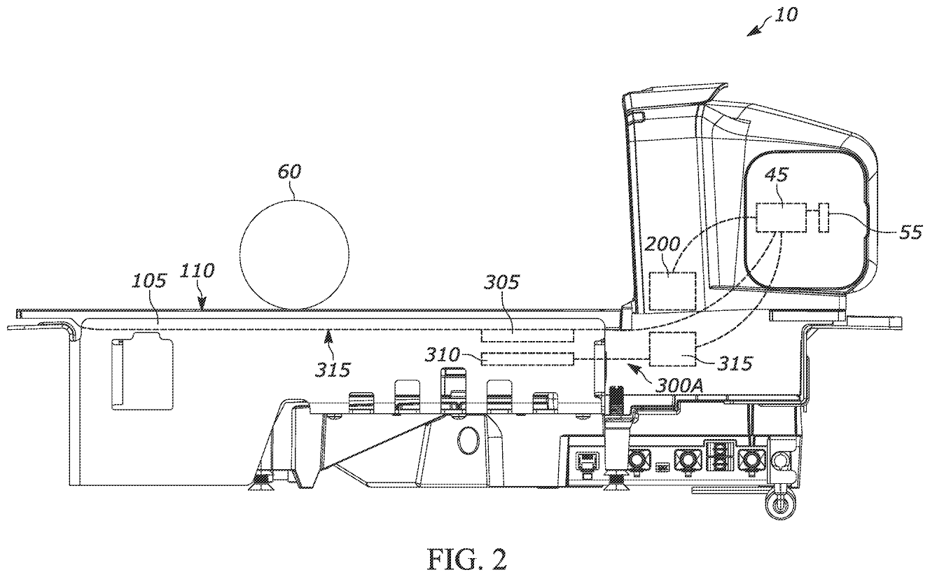

Weigh platter assembly 100 of barcode reader 10 includes a weigh platter 105 and is configured to measure the weight of an object 60 (see FIG. 2) placed on weigh platter 105. Weigh platter 105 has a top surface 110 that is generally parallel to a surface of workstation 50 and extends in a first transverse plane, a proximal edge 115, a distal edge 120, a first lateral edge 125, a second lateral edge 130, opposite top surface 110 and a bottom surface 135, opposite top surface 110. In the example shown, proximal edge 115 is adjacent upper housing portion 30 and would be the edge furthest from a user of weigh platter assembly 100 and/or barcode reader 10. First and second lateral edges 125, 130 extend non-parallel to proximal edge 115. Distal edge 120 is opposite proximal edge 115, would be the edge closest to the user, and extends non-parallel to first and second lateral edges 125, 130. In the example shown, weigh platter 105 is generally rectangular and first and second lateral edges 125, 130 are perpendicular to proximal edge 115 and distal edge 120 is perpendicular to first and second lateral edges 125, 130 and parallel to proximal edge 115. Proximal edge 115, distal edge 120, first lateral edge 125, and second lateral edge 130 together define a perimeter 140 of weigh platter 105.

Barcode reader 10 also includes an off-platter detection system 200, which is configured to detect an off-platter condition. An off-platter condition can occur when: (1) at least a portion of the weight of an object 60 is transferred to a surface other than top surface 110 of weigh platter 105, such as when a portion of object 60 is resting on a second surface off of weigh platter 105; or (2) at least some portion of object 60 placed on weigh platter 105 extends beyond perimeter 140 of weigh platter 105. Off-platter detection system 200 can be any off-platter detection system capable of detecting an off-platter condition, such as one of the off-platter detections systems disclosed in U.S. patent application Ser. No. 16/724,082, filed Dec. 20, 2019, and entitled Weigh Platter Assembly with Off-Platter Detection, U.S. patent application Ser. No. 16/724,052, filed Dec. 20, 2019, and entitled Weigh Platter Assembly with Parallax Based Off-Platter Detection, U.S. patent application Ser. No. 16/724,043, filed Dec. 20, 2019, and entitled Barcode Reader with Off-Platter Detection, U.S. patent application Ser. No. 16/724,027, filed Dec. 20, 2019, and entitled Barcode Reader with Off-Platter Detection, U.S. patent application Ser. No. 16/723,999, filed Dec. 20, 2019, and entitled Barcode Reader with Off-Platter Detection, or U.S. patent application Ser. No. 16/724,018, filed Dec. 20, 2019, and entitled Barcode Reader with Intelligent Off-Platter Indication System, each of which are incorporated herein by reference.

Referring to FIG. 2, barcode reader 10 is shown with a first example platter destabilizing mechanism 300A, which is configured to destabilize weigh platter 105 in response to off-platter detection system 200 detecting an off-platter event. Platter destabilizing mechanism 300A can destabilize weigh platter 105 for a predetermined time once off-platter detection system 200 detects the off-platter condition or, preferably, will destabilize weigh platter 105 for the entire duration while off-platter detection system 200 detects the off-platter condition. In this example, platter destabilizing mechanism 300A generally includes an electromagnetic element 305, a first wire coil 310, or other electromagnetic coil, and a power source 315. Electromagnetic element 305 could be a magnet or a second wire coil, or other electromagnetic coil, and is secured to weigh platter 105. For example, electromagnetic element 305 could be secured directly to bottom surface 135 of weigh platter 105, could be secured to bottom surface 135 of weigh platter 105 via a housing or bracket, or can be secured to weigh platter 105 by positioning electromagnetic element 305 within weigh platter 105, between top surface 110 and bottom surface 135. First wire coil 310 is positioned below weigh platter 105 and is aligned with and spaced apart from electromagnetic element 305. Power source 315 is connected to first wire coil 310 and is configured to alternate providing an electrical current to first wire coil 310 and not providing an electrical current to first wire coil 310. When power source 315 provides an electrical current to first wire coil 310, first wire coil 310 generates a magnetic field that either attracts or repels electromagnetic element 305, depending on the polarity, and provides a force to move weigh platter 105. Conversely, when power source 315 does not provide an electrical current to first wire coil 310, no magnetic field is generated and no forces are placed on weigh platter 105, which allows weigh platter 105 to return to a resting position. This generation of the magnetic field and cutting off the magnetic field moves and, therefore, destabilizes weigh platter 105 at a frequency preventing a stable weight from being achieved. Alternatively, electromagnetic element 305 and first wire coil 310 could be reversed with first wire coil 310 being secured to weigh platter 105 and electromagnetic element 305 being positioned below weigh platter 105 and aligned with and spaced apart from first wire coil 310.

A controller 45 of barcode reader 10 is in communication with weigh platter assembly 100, off-platter detection system 200, and platter destabilizing mechanism 300A and is configured to activate platter destabilizing mechanism 300A to destabilize weigh platter 105 when off-platter detection system 200 detects and indicates that there is an off-platter condition. Controller 45 can also be configured to deactivate platter destabilizing mechanism 300A once off-platter detection system 200 determines that an object position has been corrected and there is no longer an off-platter condition and to transmit a weight measured by weigh platter assembly 100 via a communications link 55 to, for example, a POS or host system once weigh platter is considered stable. Weigh platter 105 can be considered stable when an amplitude of the measured weight and a frequency of change of the measured weight are within predetermined parameters for a predetermined time. For example, weigh platter 105 could be considered stable when the amplitude of the measured weight does not fluctuate more than 0.01 pounds over a 0.5 second interval. When platter destabilizing mechanism 300A is active and weigh platter 105 is destabilized, controller 45 can be configured, for example, to: not transmit a weight measured by weigh platter assembly 100 to the POS or host system until weigh platter 105 is stabilized and a stabilized weight is received from weigh platter assembly 100; send the weight and append a status bit to the weight signal transmitted to the POS or host system indicating that weigh platter 105 is stable or is not stable; or send the weight when weigh platter 105 is stable and send the weigh append a status bit to the weight signal transmitted to the POS or host system when weigh platter 105 is not stable, as disclosed in U.S. patent application Ser. No. 17/218,379, filed Mar. 31, 2021, and entitled Methods and Apparatuses to Indicate Off-Platter Weigh Conditions, which is incorporated by reference.

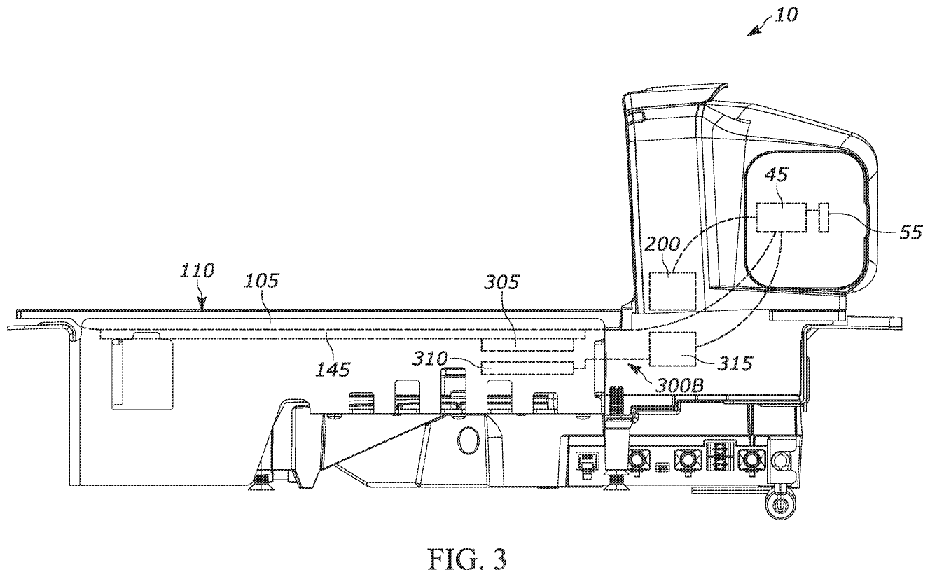

Referring to FIG. 3, barcode reader 10 is shown with a second example platter destabilizing mechanism 300B, which is also configured to destabilize weigh platter 105 in response to off-platter detection system 200 detecting an off-platter event. Platter destabilizing mechanism 300B is similar to platter destabilizing mechanism 300A, except that electromagnetic element 305 is secured to a scale arm 145 of weigh platter assembly 100, rather than weigh platter 105. As with platter destabilizing mechanism 300A, platter destabilizing mechanism 300B can destabilize weigh platter 105 for a predetermined time once off-platter detection system 200 detects the off-platter condition or, preferably, will destabilize weigh platter 105 for the entire duration while off-platter detection system 200 detects the off-platter condition. In this example, platter destabilizing mechanism 300B also generally includes electromagnetic element 305, first wire coil 310, or other electromagnetic coil, and power source 315, however, electromagnetic element 305 is secured to scale arm 145 of weigh platter assembly 100. First wire coil 310 is positioned below scale arm 145 and is aligned with and spaced apart from electromagnetic element 305. Power source 315 is connected to first wire coil 310 and is configured to alternate providing an electrical current to first wire coil 310 and not providing an electrical current to first wire coil 310. When power source 315 provides an electrical current to first wire coil 310, first wire coil 310 generates a magnetic field that either attracts or repels electromagnetic element 305, depending on the polarity, and provides a force to move scale arm 145. Conversely, when power source 315 does not provide an electrical current to first wire coil 310, no magnetic field is generated and no forces are placed on scale arm 145, which allows scale arm 145 to return to a resting position. This generation of the magnetic field and cutting off the magnetic field moves and, therefore, destabilizes scale arm 145 at a frequency preventing a stable weight from being achieved. Alternatively, electromagnetic element 305 and first wire coil 310 could be reversed with first wire coil 310 being secured to scale arm 145 and electromagnetic element 305 being positioned below scale arm 145 and aligned with and spaced apart from first wire coil 310.

Controller 45 is in communication with weigh platter assembly 100, off-platter detection system 200, and platter destabilizing mechanism 300B and is configured to activate platter destabilizing mechanism 300B to destabilize scale arm 145, and therefore weigh platter 105, when off-platter detection system 200 detects and indicates that there is an off-platter condition. Controller 45 can also be configured to deactivate platter destabilizing mechanism 300B once off-platter detection system 200 determines that an object position has been corrected and there is no longer an off-platter condition and to transmit a weight measured by weigh platter assembly 100 via communications link 55 to, for example, a POS or host system once weigh platter is considered stable. Weigh platter 105 can be considered stable when an amplitude of the measured weight and a frequency of change of the measured weight are within predetermined parameters for a predetermined time. As discussed above, when platter destabilizing mechanism 300B is active and weigh platter 105 is destabilized, controller 45 can be configured, for example, to not transmit a weight measured by weigh platter assembly 100 to the POS or host system until scale arm 145, and therefore weigh platter 105, is stabilized and a stabilized weight is received from weigh platter assembly 100 or to send the weight and append a status bit to the weight signal transmitted to the POS or host system indicating that weigh platter 105 is stable or is not stable and the transmitted weight should not be used.

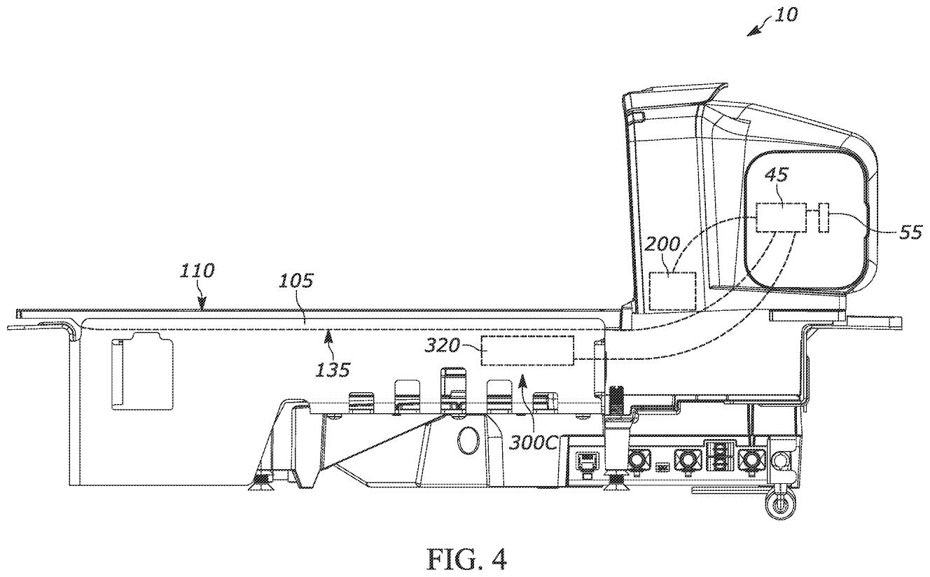

Referring to FIG. 4, barcode reader 10 is shown with a third example platter destabilizing mechanism 300C, which is also configured to destabilize weigh platter 105 in response to off-platter detection system 200 detecting an off-platter event. Platter destabilizing mechanism 300C can destabilize weigh platter 105 for a predetermined time once off-platter detection system 200 detects the off-platter condition or, preferably, will destabilize weigh platter 105 for the entire duration while off-platter detection system 200 detects the off-platter condition. In this example, platter destabilizing mechanism 300C includes a mechanical element 320, which could be a an electrically, pneumatically, or hydraulically powered striker arm configured to contact and strike weigh platter 105 at intervals or a compressed air source configured to direct compressed air towards weigh platter 105 at intervals, to destabilize weigh platter 105. Possible examples of striker arms that can be used are the Wk400-70-6-A piston from Destaco, the DSOS-0416-15D Solenoid from Digi-Key Electronics, or the 108990003 Stepper Motor from Digi-Key Electronics. In addition, a possible example of a compressed air source that can be used is the D200 Series high pressure diaphragm pumps from TCS Micropumps. Mechanical element 320 can be positioned below weigh platter 105 and can strike or direct compressed air towards bottom surface 135 of weigh platter 105 or can be positioned at other positions around weigh platter 105 and can strike or direct compressed air towards a side or top surface 110 of weigh platter 105. In addition, rather than striking or directing compressed air at weigh platter 105, mechanical element 320 can also be configured to strike or direct compressed air at scale arm 145 of weigh platter assembly 100, rather than weigh platter 105. When mechanical element 320 strikes or directs compressed air at weigh platter 105, weigh platter 105 is destabilized at a frequency preventing a stable weight from being achieved.

Controller 45 of barcode reader 10 is in communication with weigh platter assembly 100, off-platter detection system 200, and platter destabilizing mechanism 300C and is configured to activate platter destabilizing mechanism 300C to destabilize weigh platter 105 when off-platter detection system 200 detects and indicates that there is an off-platter condition. Controller 45 can also be configured to deactivate platter destabilizing mechanism 300C once off-platter detection system 200 determines that an object position has been corrected and there is no longer an off-platter condition and to transmit a weight measured by weigh platter assembly 100 via a communications link 55 to, for example, a POS or host system once weigh platter is considered stable. Weigh platter 105 can be considered stable when an amplitude of the measured weight and a frequency of change of the measured weight are within predetermined parameters for a predetermined time. As discussed above, when platter destabilizing mechanism 300C is active and weigh platter 105 is destabilized, controller 45 can be configured, for example, to not transmit a weight measured by weigh platter assembly 100 to the POS or host system until weigh platter 105 is stabilized and a stabilized weight is received from weigh platter assembly 100 or to send the weight and append a status bit to the weight signal transmitted to the POS or host system indicating that weigh platter 105 is stable or is not stable and the transmitted weight should not be used, as disclosed in U.S. patent application Ser. No. 17/218,379, filed Mar. 31, 2021, and entitled Methods and Apparatuses to Indicate Off-Platter Weigh Conditions.

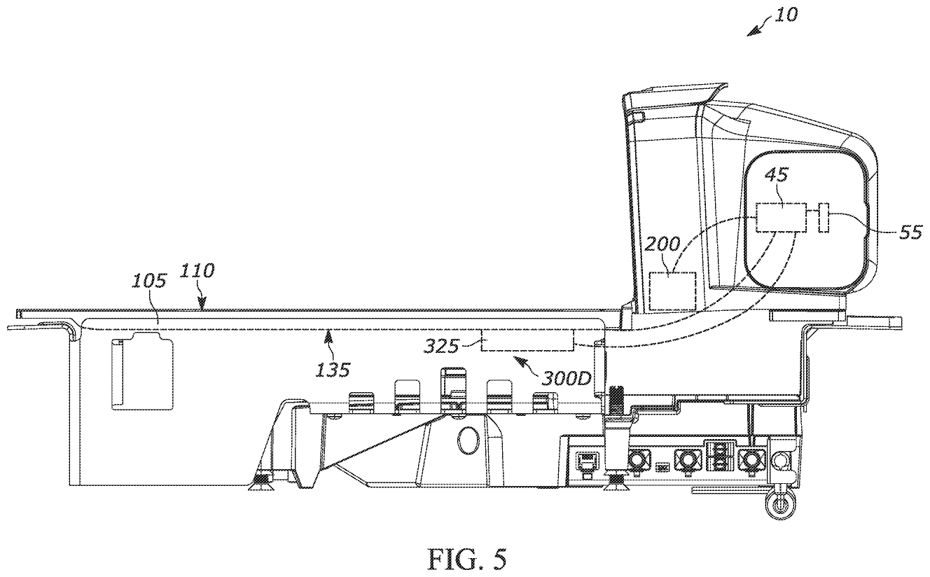

Referring to FIG. 5, barcode reader 10 is shown with a fourth example platter destabilizing mechanism 300D, which is also configured to destabilize weigh platter 105 in response to off-platter detection system 200 detecting an off-platter event. Platter destabilizing mechanism 300D can destabilize weigh platter 105 for a predetermined time once off-platter detection system 200 detects the off-platter condition or, preferably, will destabilize weigh platter 105 for the entire duration while off-platter detection system 200 detects the off-platter condition. In this example, platter destabilizing mechanism 300D includes a motor 325, which could be a vibration motor (for example a rotating mass vibrator motor, a linear resonant actuator, a solenoid, a piezoelectric vibrator motor, etc.) or a voice coil motor, secured to weigh platter 105 to destabilize weigh platter 105. Possible examples of vibration motors that can be used are the IND-SMD-003 motor from Digi-Key Electronics, the PHUA3015-30A-21-000 motor from Digi-Key Electronics, or the BMV1003H02 motor from Digi-Key Electronics. Motor 325 could be secured directly to bottom surface 135 of weigh platter 105, could be secured to bottom surface 135 of weigh platter 105 via a housing or bracket, or can be secured to weigh platter 105 by positioning motor 325 within weigh platter 105, between top surface 110 and bottom surface 135. Motor 325 can provide a movement or vibration to move and destabilize weigh platter 105. In addition, rather than being secured to weigh platter 105, motor 325 can also be secured to scale arm 145 of weigh platter assembly 100, rather than weigh platter 105. When motor 325 moves or vibrates weigh platter 105, weigh platter 105 is destabilized at a frequency preventing a stable weight from being achieved.

Controller 45 of barcode reader 10 is in communication with weigh platter assembly 100, off-platter detection system 200, and platter destabilizing mechanism 300D and is configured to activate platter destabilizing mechanism 300D to destabilize weigh platter 105 when off-platter detection system 200 detects and indicates that there is an off-platter condition. Controller 45 can also be configured to deactivate platter destabilizing mechanism 300D once off-platter detection system 200 determines that an object position has been corrected and there is no longer an off-platter condition and to transmit a weight measured by weigh platter assembly 100 via a communications link 55 to, for example, a POS or host system once weigh platter is considered stable. Weigh platter 105 can be considered stable when an amplitude of the measured weight and a frequency of change of the measured weight are within predetermined parameters for a predetermined time. As discussed above, when platter destabilizing mechanism 300D is active and weigh platter 105 is destabilized, controller 45 can be configured, for example, to not transmit a weight measured by weigh platter assembly 100 to the POS or host system until weigh platter 105 is stabilized and a stabilized weight is received from weigh platter assembly 100 or to send the weight and append a status bit to the weight signal transmitted to the POS or host system indicating that weigh platter 105 is stable or is not stable and the transmitted weight should not be used, as disclosed in U.S. patent application Ser. No. 17/218,379, filed Mar. 31, 2021, and entitled Methods and Apparatuses to Indicate Off-Platter Weigh Conditions.

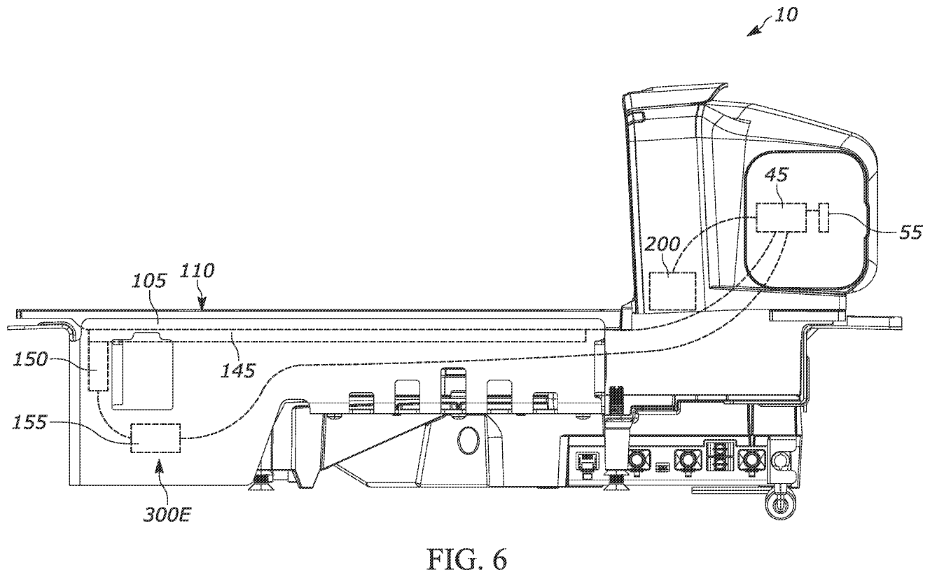

Referring to FIG. 6, barcode reader 10 is shown with a fifth example platter destabilizing mechanism 300E, which disrupts communications within weigh platter assembly 100 in response to off-platter detection system 200 detecting an off-platter event, rather than physically destabilizing weigh platter 105 or scale arm 145. Platter destabilizing mechanism 300E can disrupt communications within weigh platter assembly 100 for a predetermined time once off-platter detection system 200 detects the off-platter condition or, preferably, will disrupt communications within weigh platter assembly 100 for the entire duration while off-platter detection system 200 detects the off-platter condition. In this example, scale arm 145 engages weigh platter 105 and engages a strain gauge 150 of weigh platter assembly 100 to detect weight placed on weigh platter 105. Strain gauge 150 is in analog communication with a printed circuit board (PCB) 155 of weigh platter assembly 100 to communicate changes detected by strain gauge 150 and, therefore, changes in weight on weigh platter 105. PCB 155 can also be in digital communication with controller 45 of barcode reader 10 to communicate a weight indicated by strain gauge 150. In this example, controller 45 of barcode reader 10 is configured to activate platter destabilizing mechanism 300E and introduce cross-talk into the analog communication between strain gauge 150 and PCB 155 when off-platter detection system 200 detects an off-platter condition. For example, the cross-talk could be noise generated by an electro-magnetic field, such as by an alternating current running through a wire adjacent to a wire that provides the analog communication between strain gauge 150 and PCB 155. Controller 45 can also be configured to deactivate platter destabilizing mechanism 300E once off-platter detection system 200 determines that an object position has been corrected and there is no longer an off-platter condition and to transmit a weight measured by weigh platter assembly 100 via a communications link 55 to, for example, a POS or host system once a stable communication is received from PCB 155.

Regardless of which example platter destabilization mechanism 300A-E is used, to weigh an object 60 positioned on weigh platter 105 of weigh platter assembly 100 of barcode reader 10, off-platter detection system 200 first determines if an off-platter condition is detected. If a weight is detected by weigh platter assembly 100 and off-platter detection system 200 does not detect an off-platter condition, the weight detected by weigh platter assembly 100 is communicated, recorded, and used as normal. If a weight is detected by weigh platter assembly 100 and off-platter detection system 200 detects an off-platter condition, weigh platter 105 is destabilized by a platter destabilizing mechanism 300A-D or cross-talk is introduced into the communication within weigh platter assembly 100 by platter destabilizing mechanism 300E, preferably until the off-platter condition has been corrected, so that an incorrect weight is not communicated, recorded, or used.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A barcode reader configured to be supported by a workstation, the barcode reader comprising:
a housing having a lower housing portion and an upper housing portion extending above the lower housing portion;
a weigh platter assembly including a weigh platter having a proximal edge adjacent the upper housing portion, a first lateral edge extending non-parallel to the proximal edge, and a second lateral edge, opposite the first lateral edge, extending non-parallel to the proximal edge, the weigh platter assembly configured to measure a weight of an object positioned on the weigh platter;
an off-platter detection system configured to detect an off-platter condition;
a platter destabilizing mechanism configured to destabilize the weigh platter in response to the off-platter detection system detecting the off-platter condition; and
a controller in communication with the weigh platter assembly, the off-platter detection system, and the platter destabilizing mechanism, the controller configured to activate the platter destabilizing mechanism when the off-platter detection system detects the off-platter condition.

2. The barcode reader of claim 1, wherein the controller is configured to transmit a weight measured by the weigh platter assembly via a communications link.

3. The barcode reader of claim 1, wherein the platter destabilizing mechanism destabilizes the weigh platter while the off-platter detection system detects the off-platter condition.

4. The barcode reader of claim 1, wherein the platter destabilizing mechanism comprises: a magnet secured to the weigh platter; a first wire coil positioned below the weigh platter and aligned with and spaced apart from the magnet; and a power source connected to the first wire coil, the power source configured to alternate providing an electrical current to the first wire coil and not providing an electrical current to the first wire coil to destabilize the weigh platter.

5. The barcode reader of claim 1, wherein the platter destabilizing mechanism comprises: a magnet secured to a scale arm of the weigh platter assembly; a first wire coil positioned below the scale arm and aligned with and spaced apart from the magnet; and a power source connected to the first wire coil, the power source configured to alternate providing an electrical current to the first wire coil and not providing an electrical current to the first wire coil to destabilize the weigh platter.

6. The barcode reader of claim 1, wherein the platter destabilizing mechanism comprises: a second wire coil secured to the weigh platter; a first wire coil positioned below the weigh platter and aligned with and spaced apart from the second wire coil; and a power source connected to the first wire coil, the power source configured to alternate providing an electrical current to the first wire coil and not providing an electrical current to the first wire coil to destabilize the weigh platter.

7. The barcode reader of claim 1, wherein the platter destabilizing mechanism comprises: a second wire coil secured to a scale arm of the weigh platter assembly; a first wire coil positioned below the scale arm and aligned with and spaced apart from the second wire coil; and a power source connected to the first wire coil, the power source configured to alternate providing an electrical current to the first wire coil and not providing an electrical current to the first wire coil to destabilize the weigh platter.

8. The barcode reader of claim 1, wherein the platter destabilizing mechanism comprises a striker arm configured to strike at least one of the weigh platter or a scale arm of the weigh platter assembly to destabilize the weigh platter.

9. The barcode reader of claim 8, wherein the striker arm is electrically powered, pneumatically powered, or hydraulically powered.

10. The barcode reader of claim 1, wherein the platter destabilizing mechanism comprises a compressed air source positioned below the weigh platter, the compressed air source configured to direct compressed air towards a bottom surface of the weigh platter to destabilize the weigh platter.

11. The barcode reader of claim 1, wherein the platter destabilizing mechanism comprises a vibration motor secured to at least one of the weigh platter or a scale arm of the weigh platter assembly to destabilize the weigh platter.

12. The barcode reader of claim 1, wherein the platter destabilizing mechanism comprises a voice coil motor secured to at least one of the weigh platter or a scale arm of the weigh platter assembly to destabilize the weigh platter.

13. The barcode reader of claim 1, wherein the weigh platter is considered stable with an amplitude of the measured weight and a frequency of change of the measured weight within predetermined parameters for a predetermined time.

14. A barcode reader configured to be supported by a workstation, the barcode reader comprising:
a housing having a lower housing portion and an upper housing portion extending above the lower housing portion;
a weigh platter assembly including: a weigh platter having a proximal edge adjacent the upper housing portion, a first lateral edge extending non-parallel to the proximal edge, and a second lateral edge, opposite the first lateral edge, extending non-parallel to the proximal edge; a strain gauge; and a printed circuit board in analog communication with the strain gauge, the weigh platter assembly configured to measure a weight of an object positioned on the weigh platter;
an off-platter detection system configured to detect an off-platter condition; and
a controller configured to introduce cross-talk into the analog communication between the strain gauge and the printed circuit board when the off-platter detection system detects the off-platter condition.

15. The barcode reader of claim 14, wherein the controller is configured to transmit a weight measured by the weigh platter assembly via a communications link.

16. The barcode reader of claim 14, wherein the controller is configured to introduce cross-talk into the analog communication while the off-platter detection system detects the off-platter condition.

17. The barcode reader of claim 14, wherein the weigh platter assembly comprises a scale arm that engages the weigh platter and the strain gauge.

18. The barcode reader of claim 14, wherein the printed circuit board is in digital communication with the controller of the barcode reader.

19. A method for weighing an object positioned on a weigh platter assembly of a barcode reader, comprising the steps of:
determining, using an off-platter detection system, if an off-platter condition is detected; and
destabilizing a weigh platter of the weigh platter assembly, using a platter destabilizing mechanism, in response to the off-platter detection system detecting the off-platter condition.

20. The method of claim 19, wherein: the platter destabilizing mechanism comprises a magnet secured to the weigh platter and a first wire coil positioned below the weigh platter and aligned with and spaced apart from the magnet; and destabilizing the weigh platter includes alternating providing an electrical current to the first wire coil and not providing an electrical current to the first wire coil to destabilize the weigh platter.

21. The method of claim 19, wherein: the platter destabilizing mechanism comprises a magnet secured to a scale arm of the weigh platter assembly and a first wire coil positioned below a scale arm of the weigh platter assembly and aligned with and spaced apart from the magnet; and destabilizing the weigh platter includes alternating providing an electrical current to the first wire coil and not providing an electrical current to the first wire coil to destabilize the weigh platter.

22. The method of claim 19, wherein: the platter destabilizing mechanism comprises a second wire coil secured to the weigh platter and a first wire coil positioned below the weigh platter and aligned with and spaced apart from the second wire coil; and destabilizing the weigh platter includes alternating providing an electrical current to the first wire coil and not providing an electrical current to the first wire coil to destabilize the weigh platter.

23. The method of claim 19, wherein: the platter destabilizing mechanism comprises a second wire coil secured to a scale arm of the weigh platter assembly and a first wire coil positioned below the scale arm and aligned with and spaced apart from the second wire coil; and destabilizing the weigh platter includes alternating providing an electrical current to the first wire coil and not providing an electrical current to the first wire coil to destabilize the weigh platter.

24. The method of claim 19, wherein: the platter destabilizing mechanism comprises a striker arm; and destabilizing the weigh platter includes activating and deactivating the striker arm to strike at least one of the weigh platter or a scale arm of the weigh platter assembly to destabilize the weigh platter.

25. The method of claim 24, wherein the striker arm is electrically powered, pneumatically powered, or hydraulically powered.

26. The method of claim 19, wherein: the platter destabilizing mechanism comprises a compressed air source positioned below the weigh platter; and destabilizing the weigh platter includes directing compressed air from the compressed air source towards a bottom surface of the weigh platter to destabilize the weigh platter.

27. The method of claim 19, wherein the platter destabilizing mechanism comprises a vibration motor secured to at least one of the weigh platter or a scale arm of the weigh platter assembly to destabilize the weigh platter.

28. The method of claim 19, wherein the platter destabilizing mechanism comprises a voice coil motor secured to at least one of the weigh platter or a scale arm of the weigh platter assembly to destabilize the weigh platter.
